(19) United States
(12) Patent Application Publication
(10) Pub. No.: US 2025/0245310 A1
(43) Pub. Date: Jul. 31, 2025

(54) Multi-Device Application Continuation System and Method

(71) Applicant: The Toronto-Dominion Bank, Toronto (CA)

(72) Inventors: Gary Fong, Toronto (CA); Jung Sook Lim, Markham (CA); Yetunde Adunni Rufai, Toronto, CA (US); Ethel Zlotnik Chavez, Toronto (CA); Claire Wilcox, Toronto (CA)

(21) Appl. No.: 18/422,562

(22) Filed: Jan. 25, 2024

(51) Int. Cl. G06F 21/44

(52) U.S. Cl. CPC G06F 21/44

(57) ABSTRACT

The present disclosure relates to computer-implemented methods, software, and systems for transferring contexts in an application-based process from a first device associated with a user to a second device associated with the user while preserving state-specific information. In one example, an application-based process is initialized on a first device associated with a user. Instructions are received to transfer the process in a first state from the first device to a second device associated with the user. A secure transfer process is initiated from the first device to the second device, and the user is authenticated at the second device. In response to authenticating the user at the second device, the process is initialized at the second device in the first state. An action associated with the process is received from the user at the second device, where the action moves the process to a second state.

### TECHNICAL FIELD

The present disclosure relates to computer-implemented methods, software, and systems for transferring contexts in an application-based process from a first device associated with a user to a second device associated with the user while preserving state-specific information.

### BACKGROUND

Interactive applications and forms are being used in place of handwritten applications and forms in modern business. Interactive applications and forms can be completed on a desktop computer, mobile phone, or tablet, and allows users to quickly submit their information. Different devices have different capabilities, and different actions in an application completion process may require different capabilities on different devices.

### SUMMARY

The present disclosure generally relates to systems, software, and computer-implemented methods for transferring contexts in an application-based process from a first device associated with a user to a second device associated with the user while preserving state-specific information.

A first example method includes initializing an application-based process on a first device associated with a user, receiving instructions to transfer the application-based process from the first device to a second device associated with the user, wherein the application-based process at the first device is in a first state, and initiating a secure transfer process from the first device to the second device. The user is authenticated at the second device, and, in response to authenticating the user at the second device, the application-based process is initialized at the second device in the first state. At least one action or input associated with the application-based process is received from the user at the second device, where the at least one action or input moves the application-based process to a second state.

Implementations can optionally include one or more of the following features.

In some implementations, the operations further include receiving instructions to transfer the application-based process from the second device to a third device associated with the user, wherein the application-based process at the second device is in a third state. A secure transfer process is then initiated from the second device to the third device, where the user is authenticated at the third device. In response to authenticating the user at the third device, the application-based process is initialized at the third device in the third state.

In some of those instances, the third device is different than the first device.

In some instances, the first device is a desktop computer and the second device is a smartphone. In other instances, the first device is a smartphone and the second device is a desktop computer.

In some instances, the instructions to transfer the application-based process from the first device to a second device associated with the user are received from a user interface interaction of the user at the first device.

In some instances, the instructions to transfer the application-based process from the first device to a second device associated with the user are automatically generated by the application-based process based on a determination that the first device is without a set of functionality associated with a particular operation in the application-based process.

In some of those instances, the particular operation requires camera functionality, where the first device does not include camera functionality, and the second device does include camera functionality.

In some instances, after the secure transfer from the first device to the second device and the initialization of the application-based process at the second state, the application-based process remains active at the first device.

In some of those instances, the operations further include, in response to receiving the at least one action or input associated with the application-based process from the user at the second device moving the application-based process to the second state, updating the state of the application-based process at the first device to the same second state as the state of the application-based process at the second device.

In some instances, initiating the secure transfer process from the first device to the second device includes presenting, at the first device, a scannable code, wherein when the scannable code is scanned by the second device, the second device transmits a request to access the application-based process. In response to receiving an indication from that the scannable code has been scanned by the second device, the application-based process is initialized at the second device.

In some instances, receiving instructions to transfer the application-based process from the first device to a second device associated with the user includes presenting, at a user interface of the first device, a list of at least one trusted device associated with the user other than the first device. An indication of a selection of a particular one of the at least one trusted devices as the second device is received, and, in response to receiving the indication of the selection of the particular one of the at least one trusted devices as the second device, a notification is transmitted to the second device to transfer the application-based process from the first device to the second device.

Similar operations and processes associated with each example system can be performed in different systems comprising at least one processor and a memory communicatively coupled to the at least one processor where the memory stores instructions that when executed cause the at least one processor to perform the operations. Further, a non-transitory computer-readable medium storing instructions which, when executed, cause at least one processor to perform the operations can also be contemplated. Additionally, similar operations can be associated with or provided as computer-implemented software embodied on tangible, non-transitory media that processes and transforms the respective data, some or all of the aspects can be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram of an example environment for transferring contexts in an application-based process from a first device associated with a user to a second device associated with the user while preserving state-specific information.

FIG. 2 is an interactive illustration of session flow between components of an example system for transferring contexts in an application-based process from a first device associated with a user to a second device associated with the user.

FIGS. 3A-C illustrate example user interfaces (UIs) associated with the transfer of contexts from a first device to a second device in example implementations.

FIG. 4 is a flow diagram of an example method for transferring contexts in an application-based process from a first device associated with a user to a second device associated with the user.

FIG. 5A is a flow diagram of an optional method performed while initiating a secure transfer in some instances.

FIG. 5B is a flow diagram of an optional method performed for selecting and initiating an application session at a second device in some instances.

### DETAILED DESCRIPTION

The present disclosure generally relates to computer-implemented methods, software, and systems for transferring contexts in an application-based process from a first device associated with a user to a second device associated with the user while preserving state-specific information.

Current application processes, such as online loan applications, generally require customers to perform interactions at a single location or on a single device. In some instances, a link may be provided to allow customers to scan a QR code to open an application on their mobile (or other computing) device. Generally, however, electronic applications are initially prepared via a desktop computer. In some instances, particular information (e.g., for personal or vendor identification, such as a copy of a governmental ID) may be required to be captured for the process to continue, allowing appropriate systems to validate the identity of the person interacting with the solution and the application or form. Generally, providing that information is difficult on a desktop system absent a stored file including the needed information, as the desktop usually does not have a camera attached.

In some current solutions, the application procedure can be transferred to a phone, such as by scanning a quick response (QR) code presented on the desktop system, where, upon scanning, the transaction would begin or continue via phone input. In some instances, emails may be sent to a particular communication channel of the user to start the process there. However, in these solutions, no manner to return to the desktop system is provided after moving to the mobile device. In still other instances, moving to a third device may be desirable after switching from the first device to the second device. No such manner of moving from device to device is currently provided. Specifically, once at the new device, the process is not able to be sent back to the first device (i.e., desktop), and the option to continue at the desktop is non-existent. Because much of the process may be easier or more convenient at the first device, such a process would be advantageous.

Additionally, while sometimes described as moving from a desktop system to a mobile system, any movement between devices can be performed using the present solution. In some instances, users may begin an application process while on the move (e.g., during a commute, away from their desktop computer, etc.). As such, the process may begin on a mobile device. As they move to a fixed location, such as a home or an office, it may be useful to use the screen size and keyboard and mouse functionality of a desktop system. In those instances, the first device can be the mobile device, and the second device can be a desktop computer. Similarly, movement from a first mobile device (e.g., a smartphone) to a second mobile device (e.g., a computing tablet) may be desired, either for larger screen space, a near-empty battery on the first device, or a more comfortable means of input, among others. Any number of transfers can be used by the solution, allowing near-infinite movement between devices to complete forms and applications. This can especially be useful for detailed applications where completion of the application may occur at multiple locations, particularly where at least a portion of the application is completed on the go.

In general, the proposed solution allows applicants and customers to begin a process on a first device, and, during the process they are performing, handoff the process from the first device to a different second device, including non-co-located devices, to continue the process on the second device. Once performing the process on the second device, the applicant or customer can then optionally transfer the process to a third device. In some instances, the third device may be the same as the first device (e.g., a desktop computer, a move to a mobile device, and then back to the same desktop computer). In other instances, the third device may be different than the first and second devices (e.g., a desktop computer at work or at a financial institution, to a mobile phone associated with user, and then to home laptop associated with the user).

In one example implementing the described solution, a user or customer initiates a financial account opening application (or any other suitable financial action) via an application and/or a web browser on a first device (i.e., a desktop computer). After completing a portion of the application, the customer may then decide to move the application completion process to a new device. As described herein, the proposed process allows a secure transfer to the newly identified device. Specifically, after determining that a transfer is to be initiated, the first device can be caused to present a transfer user interface (UI).

Using the transfer UI, a secure application session is established on the second device, and the same application completion process that was being performed on the first device is opened and presented to the customer on the second device. That application completion process is taken to the same state as previously reached on the first device.

Once the second device is a trusted device (e.g., via secure login/authentication/etc.), the financial interaction process can continue, allowing the second device to connect and work with the secure financial systems needed to perform the application completion financial process, in some instances using additional functionality of the second device. In some instances, the move to a second device may be for functionality and/or interactions related to identity proofing (IDP). Using the second device, the customer may be able to complete the next actions for the IDP, which can include providing images of documents securely for identification confirmation. As desktop computers may not have cameras available to them, the second device may be a mobile device that includes an integrated camera. When performing the process on the mobile device, that integrated camera can be used to capture images of the required documents (e.g., a drivers' license, proof of income, etc.). By providing the information via functionality of the second device, the second device and the customer can be authenticated by the IDP system for purposes of the overall financial process.

In some instances, a particular device may be known or pre-authenticated as associated with a user or customer. Therefore, by transferring a process to a particular device, the identity of the user may be verified for some identity verification and processing without further interactions being required. In such instances, transfer to a trusted second device from a first device may automatically allow the identity proofing to be completed without more, allowing for quick authentication of the user.

In some instances, transfer to one or more other devices may be performed via the transfer UI, with the user able to select a second associated device. When those devices are pre-registered and connected to the user's account, or to the user, those options may be presented and selectable via the transfer UI. Once selected, the second device can be connected to the ongoing process via secure messages sent to the second device or an account associated therewith. In some instances, a push notification may be provided via a financial application, or may be sent via text or other messaging. Once the link or notification is opened on the second device, the transfer UI may be presented within an application and/or browser on the second device, and the user may be logged in without additional interaction or sign-on, in some instances.

Once authenticated on the second device, the user can continue the application process on the second device, and, after completing the one or more next operations or steps of the process, the user can choose to continue on the same second device, to return to the original first device, or to move the process to a new third device.

In some instances, the secured transfer can be completed using any suitable mechanism. One mechanism may be allowing the second device to scan a QR or other barcode image as presented by the first device, causing a secure link to the second device to be made and a suitable application or web page loaded on the second device. Alternatively, NFC, Bluetooth, or other similar connections from the first device to the second device can be used. Additionally, the secure transfer UI and process can allow users to send SMS and email communications to their other devices. In some instances, security codes can be provided for entry and confirmation of the user, as well. In other instances, the devices may be directly connected or otherwise trusted, and no further input may be necessary.

In some instances, the transfer may be for a particular and/or singular task. In those instances, a continue UI may be available and provided to the user after the task is completed, which can allow the user to select whether to continue on the second device or return to the first device. If a previous device is no longer available, or a third device is desired, input can be used to log into a third device. No limit on the number of devices is set, and any device associated with the user may be used.

In some instances, the solution may be multi-threaded, such that a session may remain open on a first device while moving to the second device. The UI or interactions on the first device can be updated when the operations on the second device are performed, such as showing that a next step has finished via a UI when operations are performed on the second device. The user could continue working on the second device, or could return to the first device. In some instances, the first device can be updated immediately in response to an interaction on the second device, while in other instances, the first device may poll or otherwise check periodically with the centralized process to determine if updates have been made on a second device.

In some instances, the process could be started at a mobile device as the first device of the user. The process can then be moved to a desktop or other more convenient device (e.g., to a tablet or other device with more screen space) as the second device.

Among other benefits, the present solution allows for ease of movement between devices, allowing the handoff and continuance of a suitable application or other step-based process between different devices associated with a user without the solution being in a specifically non-OS-based continuation. Any combination of devices and operating systems can be used to allow the transfer.

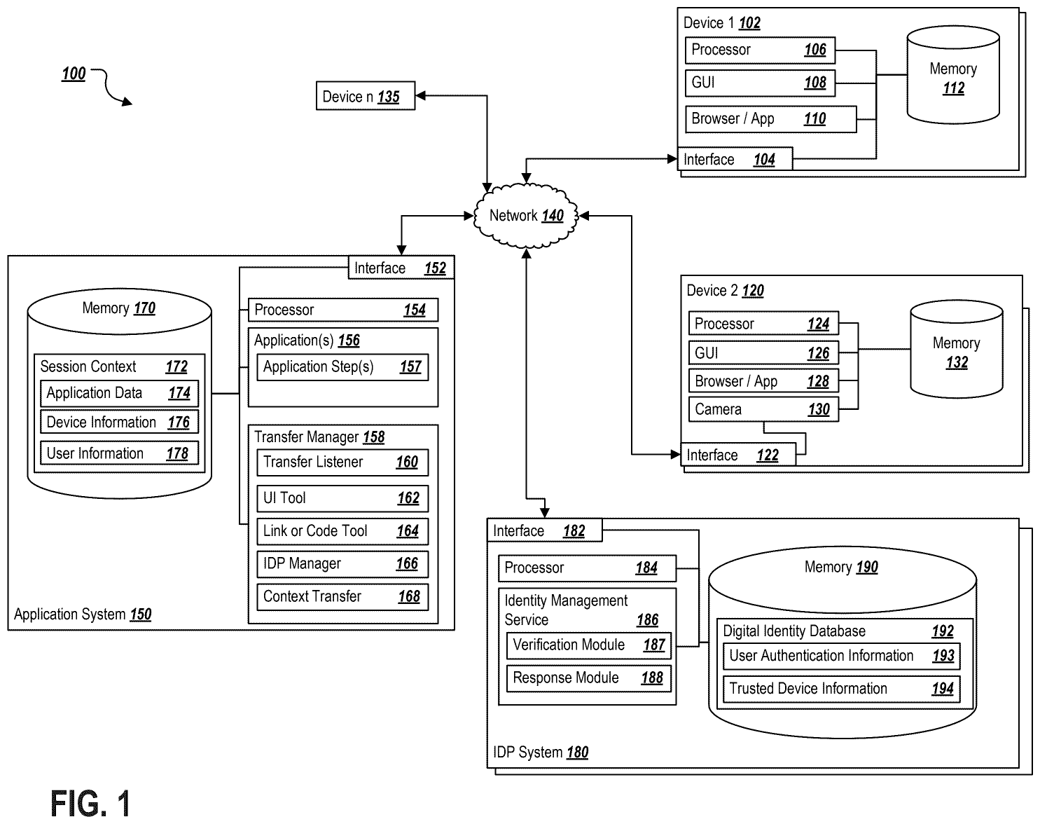

Turning to the illustrated example implementation, FIG. 1 is a block diagram of an example environment 100 for transferring contexts in an application-based process from a first device associated with a user to a second device associated with the user while preserving state-specific information. Additionally, the process allows the user to easily return to the first device, or move to a new third device, without difficulty and with minimal friction. Various types of processes and operations can be used and implemented with the described solution. Application processes may include multi-operation interactions with various computing systems, from financial systems, to educational systems, to form completion for businesses, among others. Generally, the application processes described herein include step-by-step operations of providing information, inputs, and/or analysis into web- or application-based interfaces, where state information is saved as the process moves between operations. Users can submit information, and, after submission, the application process may move to a next step or operation associated with a new or updated UI.

As shown in FIG. 1, the example environment 100 includes a first device 102, a second device 120, and one or more other devices 135, as well as an application system 150, and an identity provider (IDP) system 180, where these components are connected by a network 140. The function and operation of each of these components is described below. The application system 150 may be any suitable system associated with one or more applications 156, where those applications 156 are associated with corresponding application steps 157. The applications 156 may be software associated with larger software systems, or they may be standalone software. In general, the applications 156 are used to perform step-by-step operations associated with users, where a specific state is maintained and stored in the application system 150 such that the same state may be accessible on two or more devices associated with a user. One example process performed by the application 156 illustrated in FIG. 1 is for an online account opening process at a financial institution. Other users may include, but are not limited to, check-in processes at doctor's offices, job application submission, troubleshooting and ticket submission in an information technology (IT) solution, and consumer-based ordering processes, among others. Other similar systems may also be associated with environment 100, but are not illustrated here.

As described above, the example environment 100 enables the illustrated components to share and communicate information across devices and systems (e.g., the application system 150, the IDP system 180, and each of the devices 102, 120, and 135, among others) via network 140. As described herein, some of these systems can be cloud-based components or systems (e.g., partially or fully), while in other instances, non-cloud-based systems can be used. In some instances, non-cloud-based systems, such as on-premises systems, client-server applications, and applications running on one or more client devices, as well as combinations thereof, can use or adapt the processes described herein. Users using one or more of the devices may remotely access portions of the other systems via Internet or other suitable connections. Although components are shown individually, in some implementations, functionality of two or more components, systems, or servers can be provided by a single component, system, or server. Conversely, functionality that is shown or described as being performed by one component, can be performed and/or provided by two or more components, systems, or servers.

As used in the present disclosure, the term “computer” is intended to encompass any suitable processing device. For example, the application system 150, the devices 102, 120, and 135, and/or the IDP system 180 can be any computer or processing devices such as, for example, a blade server, general-purpose personal computer (PC), Mac®, workstation, UNIX-based workstation, or any other suitable device. Moreover, although FIG. 1 illustrates a single application system 150, the application system 150 can be implemented using a single system or more than those illustrated, as well as computers other than servers, including a server pool. Similarly, the IDP system 180 can be implemented as one or more components and/or computers. In other words, the present disclosure contemplates computers other than general-purpose computers, as well as computers without conventional operating systems.

Similarly, each device 102, 120, and 135 can be any system that can request data and/or interact with the application system 150, the IDP system 180, and/or the other devices, among others. Devices 102, 120, and 135, in some instances, can be any one of a desktop system, a client terminal, or any other suitable device, including a mobile device, such as a smartphone, tablet, smartwatch, or any other mobile computing device. In some instances, the first device 102 may be different in device type than the second device 120, such as where the first device 102 is a desktop computer, while the second device 120 is a mobile device such as a smartphone. In other instances, however, some or all of devices 102, 120, and 135 may be the same type of device. In general, each illustrated component can be adapted to execute any suitable operating system, including Linux, UNIX, Windows, Mac OS®, Java™, Android™, Windows Phone OS, or iOS™, among others. As illustrated in FIG. 1, the first device 102 is a device that does not include a camera, while the second device 120 does include camera 130. In situations and operations where a camera is needed or would otherwise make the process more convenient, the present solution can, as an example, transfer the process from the first device 102 to the second device 120.

In starting the application 156, the first device 102 can use a browser or dedicated application 110 to access the application system 150 and its applications 156. At some point during execution of the application 156, the user may choose to move the execution of the process from the first device 102 to a second device 120, or alternatively, to one of the additional other devices 135. To do so, the application system 150 can provide a transfer manager 158, where the transfer manager 158 facilitates the moving of the process from the first device 102 to the second device 120. As illustrated, the transfer manager 158 can include a transfer listener 160, a UI tool 162, a link or code tool 164, an IDP manager 166, and a context transfer module 168.

The transfer listener 160 can monitor interactions with the different application steps 157 of application 156 and the user at the first device 102. In some instances, the application 156 may determine that functionality not present at the first device 102 may be needed or desirable, and can initiate a secure transfer to another device (e.g., the second device 120). In those instances, the transfer listener 160 may automatically determine, based on the application steps 157 and information about the capabilities of the first device 102 (e.g., based on device information 176 stored in memory 170), initiate a possible secure transfer process. In other instances, the application steps 157 themselves may be associated with indicators, flags, or other information or metadata that indicates a potential transfer may be of interest to the user. Alternatively, the transfer listener may determine that the user, via the first device 102, has proactively initiated or indicated that a transfer is desired, such as through a UI interaction or other input or command.

Once the secure transfer process is determined to potentially begin or to be offered, the UI tool 162 can be used to generate a secure transfer UI, where instructions associated with performing the transfer are presented. The UI tool 162 can work with a link or code tool 164 to provide a unique code, link, barcode, QR code, or other method of transferring the application process to a new device. The UI tool 162 can also include UI elements that allow a user to decline to transfer the process, in some cases. In some instances, the transfer manager 158 can provide different methods of transferring the process to the second device 120. In some instances, the transfer manager 158 can be used, via the functionality of the first device 102, to cause the first device 102 and the second device 120 to wireless connect to one another, such as through a Bluetooth, NFC, or other connection method. In other instances, the transfer manager 158 may be aware of one or more trusted devices associated with the user. For example, the user may have a mobile application associated with the application system 150 and/or the entity controlling or associated with the application 156, and that device may already be established as associated with the same user. In those instances, a transfer to the second device from the first device may be actuated through a secure message sent through the particular entity's application 128 on the second device 120, such that logging into that application executing on the second device 120 may immediately, without further authentication, allow for the application 156 to reach its current state with the user already authenticated.

Returning to the first device 102, as illustrated device 102 can include an interface 104, processor 106, graphical user interface (GUI) 108, at least one browser or mobile application 110, and memory 112. The browser or application 110 can be a web browser or mobile web browser, or may be browser embedded or included in another application. In some instances, the browser 110 can include or execute one or more web browsers or web applications that can interact with particular applications executing remotely from the device 102, such as the application system 150, the IDP system 180, and/or one or more web pages or other relevant applications, among others. In still other instances, the application 110 may be a dedicated application at the first device 102, where the application 110 can present information from the application 156 and any associated UIs provided by the transfer manager 158. In other instances, the browser or application 110 can be a remote agent, component, or client-side version of the application system 150. In some instances, the browser 110 can interact directly or indirectly (e.g., via a proxy server or device) with the application system 150, or portions thereof. The browser 110 can be used to view, interact with, or otherwise transact data exchanges and activities with the application system 150 and the application 156 or the IDP system 180, as well as other systems, and to allow interactions associated with the subject matter described herein. Browser or application 128 may be similar to the browser or application 110, or may be a device type-specific application (e.g., a mobile browser or mobile application) as compared to the first device's desktop browser or installed desktop application, in some instances.

Although FIG. 1 illustrates a three devices 102, 120, and 135, more or fewer devices can be deployed and in use according to the particular needs, desires, or particular implementations of the environment 100. In the present implementation, each device is associated with the same user, or alternatively, can be associated with the same user after the user interacts with that device and provides the user's associated credentials or other authorization. One or more of the devices may be associated with more than one user, or may be a public or non-private device where multiple users can interact with the device. As illustrated in the first device 102 and the second device 120, and which is not shown in device 135, each device may include an interface (104, 122) for communication, at least one processor (106, 124), a GUI (108, 126), the browser or client application (110, 128), and a memory (112, 132) storing information associated with the respective device. As illustrated, the example devices herein are different in that the first device 102 does not include a camera, while the second device does (i.e., camera 130). For that reason, application steps 157 associated with the submission or uploading of a photo may be easier performed on the second device 120 instead of at the first device 102.

GUI 108 of the first device 102 interfaces with at least a portion of the environment 100 for any suitable purpose, including generating a visual representation of any particular browser or application 110 and/or the content associated with any components of the application 156 or other portions of the application system 150, the IDP system 180, other systems, and/or other devices. For example, the GUI 108 can be used to present screens and information associated with the application 156 (e.g., UI interfaces used to present the operation steps of the application 156) and interactions associated therewith, as well as presentations associated with the IDP system 180 (e.g., for authenticating the user at one of the devices), as well as interfaces associated with any suitable purpose of the first device 102, among other possibilities. GUI 108 can also be used to view and interact with various web pages, applications, and web services located local or external to the first device 102. Generally, the GUI 108 provides the user with an efficient and user-friendly presentation of data provided by or communicated within the system. The GUI 108 can comprise a plurality of customizable frames or views having interactive fields, pull-down lists, and buttons operated by the user. In general, the GUI 108 is often configurable, supports a combination of tables and graphs (bar, line, pie, status dials, etc.), and is able to build real-time portals, application windows, and presentations. Therefore, the GUI 108 contemplates any suitable graphical user interface, such as a combination of a generic web browser, a web-enable application, intelligent engine, and command line interface (CLI) that processes information in the platform and efficiently presents the results to the user visually. GUI 126 of the second device 120 may be similar to or different than GUI 108.

The interface 104 of the first device 102 is used by the first device 102 for communicating with other systems in a distributed environment—including within the environment 100—connected to the network 140, e.g., the application system 150, the IDP system 180, other device(s) 120, 135, and other systems communicably coupled to the first device 102 and/or network 140. Generally, the interface 104 comprises logic encoded in software and/or hardware in a suitable combination and operable to communicate with the network 140 and other components. More specifically, the interface 104 can comprise software supporting one or more communication protocols associated with communications such that the network 140 and/or interface's hardware is operable to communicate physical signals within and outside of the illustrated environment 100. Still further, the interface 104 can allow the first device 102 to communicate with the connected or communicably coupled components illustrated in FIG. 1, as well as other systems not illustrated herein.

Network 140 facilitates wireless or wireline communications between the components of the environment 100 (e.g., between the application system 150, the devices 102, 120, 135, and/or the IDP system 180, etc.), as well as with any other local or remote computers, such as additional devices, clients, servers, or other devices communicably coupled to network 140, including those not illustrated in FIG. 1. In the illustrated environment, the network 140 is depicted as a single network, but can be comprised of more than one network without departing from the scope of this disclosure, so long as at least a portion of the network 140 can facilitate communications between senders and recipients. In some instances, one or more of the illustrated components can be included within or deployed to network 140 or a portion thereof as one or more cloud-based services or operations. The network 140 can be all or a portion of an enterprise or secured network, while in another instance, at least a portion of the network 140 can represent a connection to the Internet. In some instances, a portion of the network 140 can be a virtual private network (VPN). Further, all or a portion of the network 140 can comprise either a wireline or wireless link. Example wireless links can include 802.11a/b/g/n/ac, 802.20, 5G, LTE, and/or any other appropriate wireless link. In other words, the network 140 encompasses any internal or external network, networks, sub-network, or combination thereof operable to facilitate communications between various computing components inside and outside the illustrated environment 100. The network 140 can communicate, for example, Internet Protocol (IP) packets, Frame Relay frames, Asynchronous Transfer Mode (ATM) cells, voice, video, data, and other suitable information between network addresses. The network 140 can also include one or more local area networks (LANs), radio access networks (RANs), metropolitan area networks (MANs), wide area networks (WANs), all or a portion of the Internet, and/or any other communication system or systems at one or more locations.

Memory 112 of the first device 102 can represent a single memory or multiple memories. The memory 112 can include any memory or database module and can take the form of volatile or non-volatile memory including, without limitation, magnetic media, optical media, random access memory (RAM), read-only memory (ROM), removable media, or any other suitable local or remote memory component. The memory 112 can store various objects or data associated with the first device 102 and/or the user of the first device 102. While illustrated within the first device 102, memory 112 or any portion thereof, can be located remote from the first device 102 in some instances, including as a cloud application or repository, or as a separate cloud application or repository. Memory 112 can store any client-specific data, information, or applications for use on the first device 102. Other suitable information can also be stored or referenced within memory 112. Memory 132 of the second device 120 may be similar or different to memory 112 of the first device 102.

Although illustrated as a single processor 106 in the first device 102 in FIG. 1, multiple processors 106 can be used according to particular needs, desires, or particular implementations of the environment 100. Each processor 106 can be a central processing unit (CPU), an application specific integrated circuit (ASIC), a field-programmable gate array (FPGA), or another suitable component. Generally, the processor 106 executes instructions and manipulates data to perform the operations of the device 102. Specifically, the processor 106 executes the algorithms and operations described in the illustrated figures, as well as the various software modules and functionality, including the functionality for sending communications to and receiving transmissions from the first device 102 to other components in environment 100, as well as to other devices and systems. Each processor 106 can have a single or multiple cores, with each core available to host and execute an individual processing thread. Further, the number of, types of, and particular processors 106 used to execute the operations described herein can be dynamically determined based on a number of requests, interactions, and operations associated with the first device 102. Similarly, processor 124 of the second device 120 may be similar to or different than processor 106. Additionally, processors 154 and 184 of the application system 150 and IDP system 180, respectively, may also be similar to or different than processor 106.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component can be fully or partially written or described in any appropriate computer language including, e.g., C, C++, JavaScript, Java™, Visual Basic, assembler, Perl®, any suitable version of 4GL, as well as others.

Returning to the application system 150, the application system 150 as illustrated includes interface 152 (which may be similar to or different than interface 104 and 122), one or more applications (156) (as described above), the transfer manager 158 (as described above), and memory 170 (similar to or different than memories 112 and 132).

Returning specifically to the transfer manager 158, the transfer manager 158 may include an IDP manager 166. The IDP manager 166 can be used by the application system 150 to verify and authenticate users at the devices, and may assist in ensuring that the application 156 not execute at a new device until the user is authenticated or otherwise verified at a particular device. In some instances, the IDP manager 166 can take information associated with the user and/or the device(s) of the user to assist in the authentication and verification process.

The transfer manager 158 also includes a context transfer module 168. In some instances, the context transfer module 168 can be used to push a current context associated with the application 150 to one or more of the devices associated with the user. For example, if the user transfers to the second device 120, the context transfer module 168 may assist in providing information and context to the second device 120 and its browser or application 128 such that the second device 120 can be placed into the proper context as left off at the first device 102. Similarly, if multiple connections to devices are open for the application (i.e., the user has not logged out of the first device 102 after transferring to the second device 120), then the context transfer module 168 can update the first device's context and application 110 as interactions are performed at the second device 120.

Memory 170 of the application system 150 can store any relevant information. For purposes of the illustrated example, memory 170 stores a session context(s) 172 related to particular application sessions. In some instances, a plurality of session contexts 172 may be stored, each context 172 associated with particular users. In some instances, different users may be associated with different contexts, while in other instances, the same user may be associated with different contexts (e.g., different applications). In general, the session context 172 is meant to store information at a centralized location associated with particular instance of an application 156, and to manage the operations and inputs associated with each application step 157 of a particular application 156 instance. The session context 172 can be shared across devices when users transfer their session in a particular application 156 from the first device 102 to the second device 120 (e.g., via the context transfer module 168). As illustrated, the session context 172 may include a set of application data 174, a set of device information 176, and set of user information 178. The set of application data 174 may store answers, inputs, and outputs associated with particular operations of the application 156. The set of device information 176 may store information about the different devices associated with a particular user. In some instances, the device information 176 may only store information on devices at which a handoff has occurred via the secure transfer process. In other instances, however, the device information 176 may store known devices previously associated with a particular user. Those prior devices may be suggested as transfer targets during the secure transfer process, in some instances. The device information 176 may also store information about particular device's types, capabilities, and usage. The user information 178 may store specific information about users working on one or more instances of the application(s) 156, which can be used in part to verify identities with the IDP system 180.

As illustrated, the IDP system 180 of environment 100 is used to assist and manage identity verification procedures. In some instances, the IDP system 180 may be a part of the application system 150 or a related enterprise system, while in others, the IDP system 180 may be separate from the application system 150. As illustrated, the IDP system 180 includes processor 184 (similar to or different from processor 154), identity management service 186, and memory 190 (similar to or different from memory 170).

The IDP system 180 is a service that stores and manages digital identities. Companies use these services to allow their employees or users to connect with the resources they need. The IDP system 180 can provide a way to manage access, adding or removing privileges, while security remains tight. The IDP system 180 can be useful in the secure transfer process described herein, but requiring users to validate their identity via the IDP system 180 prior to the requested transfer occurring.

The identity management service 186 can provide the functionality provided access to the identity management and verification tools provided by the IDP system 180. The identity management service 186 includes a verification module 187 and a response module 188. The verification module 187 can interact with the devices of a user to ensure the person accessing the devices are who they say they are, and are authorized to have access to the particular application instance they are attempting to access. This may be important if the transfer requests are sent to unknown devices that may be shared by multiple users. The verification module 187 can request and receive authentication information, and compare that to information in its digital identity database 192. The digital identity database 192 an include the user authentication information 193 (e.g., user credentials, passwords, codes, or PINs associated with a particular transfer request, and more) and a set of trusted device information 194. The trusted device information 194 can be used to automatically confirm that a device is associated with the user, such as when the digital identity of the user is linked to particular devices. For example, additional credentials and user information may not be needed to validate a particular user where the device is specifically associated with a user, and is not public or otherwise accessible to others.

While portions of the elements illustrated in FIG. 1 are shown as individual components that implement the various features and functionality through various objects, methods, or other processes, the software may instead include a number of sub-components, third-party services, libraries, and such, as appropriate. Conversely, the features and functionality of various components can be combined into single components as appropriate.

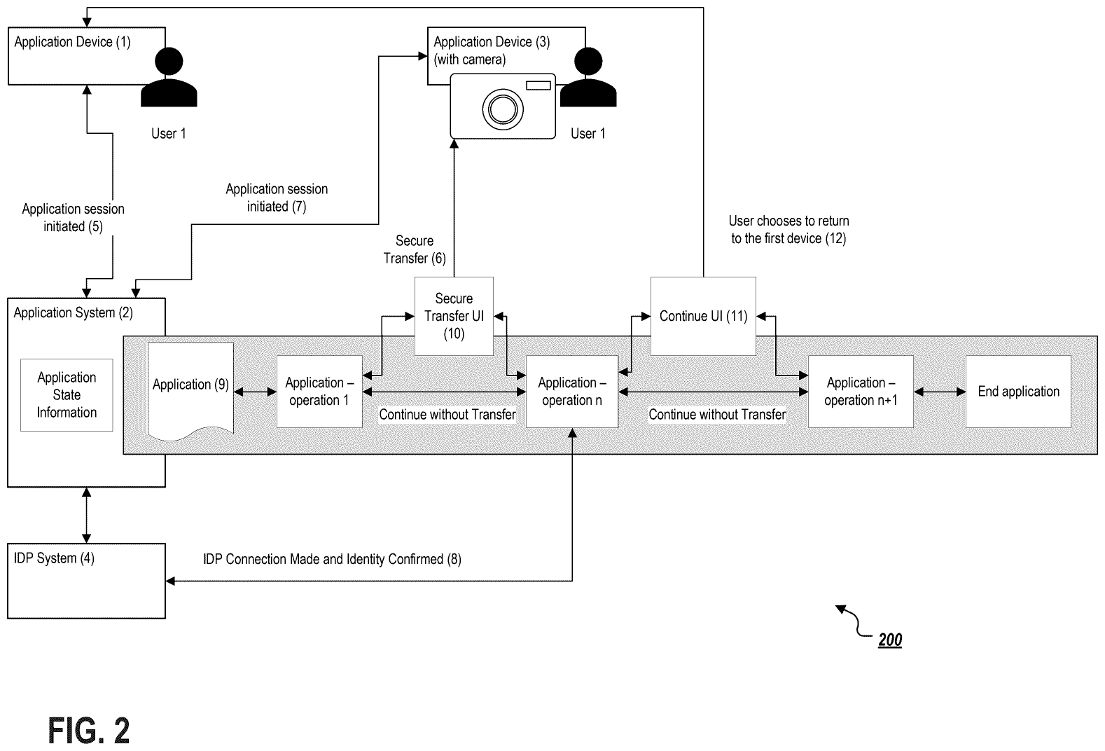

FIG. 2 is an interactive illustration of session flow between components of an example system for transferring contexts in an application-based process from a first device associated with a user to a second device associated with the user. In particular, the provided illustration is meant as an example of potential actions by a first user working between two devices, each associated with a first user, to complete an application process across different devices. In some instances, the switch between devices may be to access additional functionality of a second device as compared to a first, or may be to provide flexibility when a move to second device is more convenient, such as moving from a desktop computer to a mobile device to finish a process on the move. For the specific context of the illustrated example of FIG. 2, a financial account opening application is described. Any other suitable application process can be used in alternative examples to allow users to move from device to device in a synchronized and managed way.

As illustrated, a user can initiate a financial account opening application (2) on a desktop device (1), and can then choose to switch to a second device (3), which may be associated with a mobile phone, tablet, or other device where a camera is available. The use of the camera may be to obtain additional information, images, or photos associated with a user's identity, such as a driver's license or passport. The functionality, or access to those documents or images of them, may not be available on the first device (1), for instance. In other instances, the user may simply choose to perform operations on the second device instead of the first.

As illustrated, the first application device (1) can be used to initiate an application session (5) with the application system (2) associated with application (9). As operations are performed, the application (9) can continue its operations through various steps, beginning with an initial operation, and can store application state information at the application system (2) as operations are performed and completed. In some instances, multiple operations can be performed at the first device without a change.

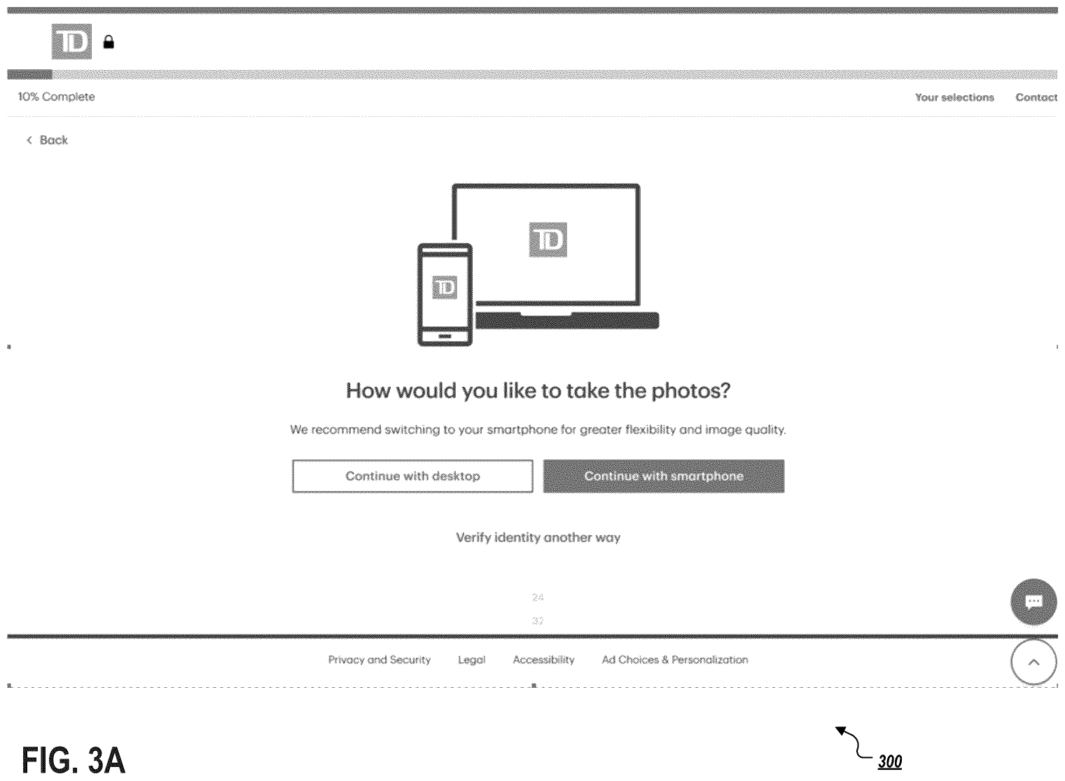

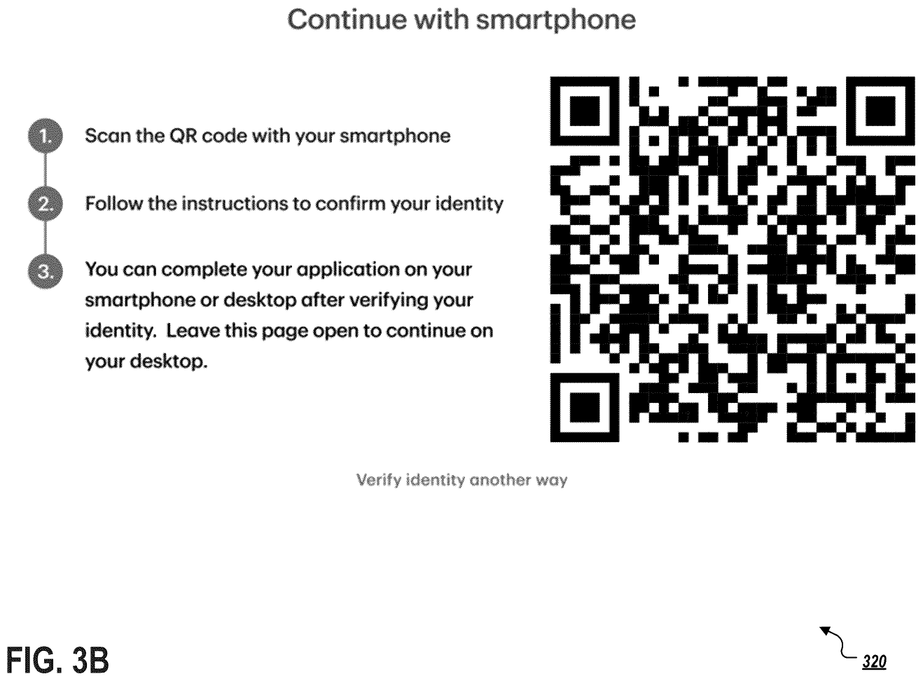

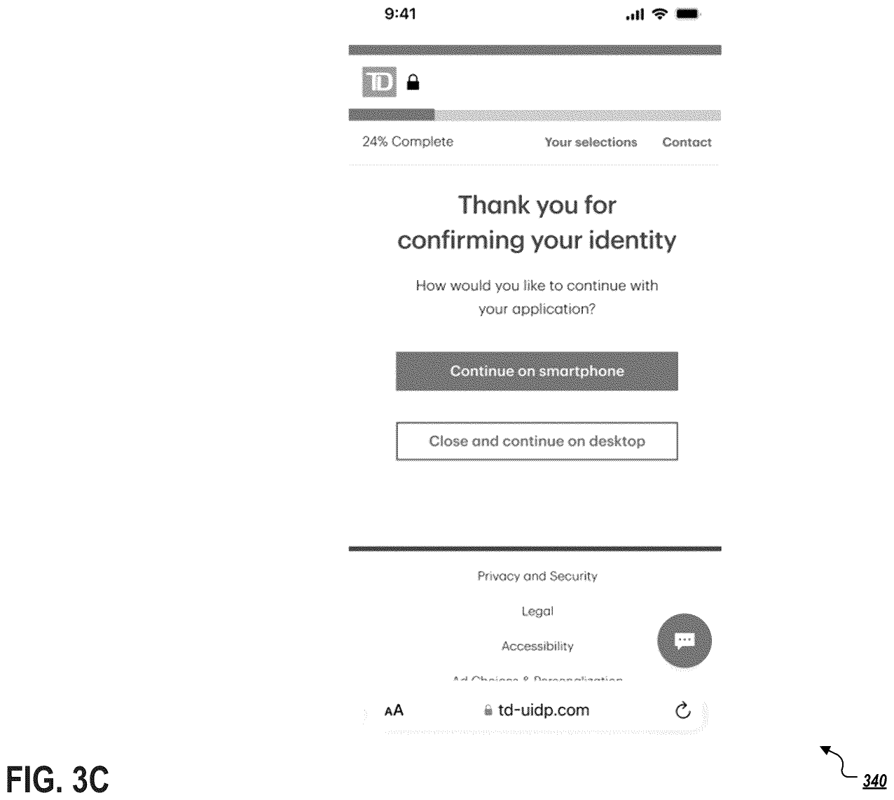

At some time during the process, the user may desire to change devices to continue with the process. To do so, a secure transfer UI (10) can be provided via the application interactions. In some instances, the secure transfer UI (10) can be triggered by a user selection within the application process, such as by clicking a button or otherwise indicating to the system that a device change is desired. In response to that indication, the secure transfer UI (10) can be generated and presented to the first user. FIG. 3 illustrates an example secure transfer UI (10). In some instance, the secure transfer UI (10) can provide, via the first device, a link, a scannable image (e.g., a barcode or QR code), or other instructions on how to initiate a new application session (7) on the second device. In some instances, a wireless connection between the first device and the second device can be used to manage the transfer, such as through NFC communications, Bluetooth connections, or other wireless connections between the devices if they are near to one another. In other instances, the secure transfer (6) process could be performed via messaging or email communication methods. In those instances, a security code can be provided securely to the user to use at the second device to guarantee the user's identity and intention to transfer the session. Once the confirmation is received at the second device, and the second device is verified and validated as associated with the same user, then the new application session (7) can be performed, where the process is placed into the appropriate operation at which the user left off on the first device.

In some instances, the application process can then be performed on the second device (3) without further transfer. In other instances, the user can elect to return, after a particular operation performed at the second device, back to the first device (1). Alternatively, a new third device could be used to continue the process instead. In those instances, a continue UI (11) may be provided after an operation is performed on the second device. The continue UI (11) can ask the user whether they would prefer to stay on the second device, or move back to the first device or to a third device to continue the process.

As illustrated here, once the second device is trusted and the application session is initiated, the second device can continue to communicate with other financial systems (e.g., the IDP, or identity proofing, system (4)). Here, the second device can be used to take a picture of the identification of the first user, such as through a picture of the user's driver's license, where the application (9) can submit the input to the validation and verification system to confirm the user's identity (8). As noted, once the user is finished, they can then be given the choice to continue their application on the same device they are on, or to return to the original starting device (1) or to move to a third device different than the first or second device.

In some instances, the application session (5) on the first device (1) may continue while the user moves to the second device (2) to continue the process in the second application state (7). In those instances, the interactions on the second device can be used in the application process, and the application state can be updated. The application session (5) on the first device can be updated, either through push updates of the status or by regular polling of the application state information.

In some instances, the first device (1) may no longer be available and/or accessible after completing a portion of the process on the second device. If the first device (1) is no longer available, the continue UI (11) may instead be the secure transfer UI (10), and can be used to move the application to a third device, if desired.

FIGS. 3A, 3B, and 3C illustrate example user interfaces (UIs) associated with the transfer of contexts from a first device to a second device in example implementations. In the illustrated examples, the application process begins at a desktop device as the first device, and moves to a mobile device as the second device.

FIG. 3A illustrates an example where the application process requires visual input, in particular, photos, of personal identifying documents such as a driver's license or passport, among others. Because the desktop computer may not have the capability to take pictures with a camera, the application process can suggest moving to a second device. In some instances, the process operations of the application may be programmed and built such that a transfer, if starting on a desktop computer, is always or typically suggested at certain operations in the application flow. In other instances, the transfer may only be initiated by user action, such as interacting with a UI element indicating a transfer to a different device is desired. As illustrated by the example screenshot 300, the application process provides users here the ability to stay on the desktop computer to provide the needed photos (e.g., for identifying purposes), or to continue on the mobile device (i.e., a smartphone) as the second device. If the user selects “Continue with desktop”, a method of uploading saved photos can be provided. If, however, the user selects “Continue with smartphone,” then the secure transfer process can continue with an example UI similar to that presented at FIG. 3B.

As illustrated in FIG. 3B, a scannable QR code is presented that can be used by scanning the image on the mobile device, which leads the user to the appropriate website or application process. In some instances, the user may need to log in with particular credentials to the application system in order to verify their identity before continuing the process. Once logged in, the user can perform the next step in the process—here, submitting images of the user's identity information.

The transfer may be performed in other ways to move from the first device to the second device. In some instances, a barcode may be provided instead of a QR code. Alternatively, local wireless technologies may be used to wireless handoff the process to the second device, such as through an NFC connection, a Bluetooth connection, or other similar options. In other instances, the secure transfer can allow the user to send a message to the second device (originating from either the application system or the first device) that can include a link, push notification, or other code (e.g., QR code, etc.) that can be used on the second device to access the application process.

As indicated in the instructions shown in FIG. 3B, the first device may stay logged into the application process while the handoff occurs and is occurring. In those instances, the status of the application process can be updated on the first device as additional inputs are received from the second device. As such, there is no need to leave the process on the first device while the additional operations are being performed on the second device, allowing users to seamlessly interact between their different devices.

FIG. 3C illustrates a continue UI presented after a particular application process operation is performed on the mobile device as the second device. In this instance, the mobile device was used to capture an image of the user's identity documents and provide those to the application system for verification, for example, when applying for a financial account. In some instances, that may be the only action that the user may want to take on the mobile device. Therefore, continue UI 340 is provided to the user after completion of the operation to offer to move back to the first device, or to continue the process on the mobile device (i.e., the second device). In some instances, other devices may be available to continue the process on, such as a third device different from the first and second devices. If the user selects “Continue on smartphone”, the next operation, question, or interaction with the application process can be presented on the mobile device. Options to transfer back to the first device or to a new third device may be presented as options or clickable/interactive links or buttons in the presentation, allowing changes at various times throughout the process. If, instead, the user selects “Close and continue on desktop,” the mobile page or application presented on the mobile device can be closed. In some instances, additional operations and a new secure transfer UI may be presented to allow the user to transfer to a particular device. In others, such as where the user has kept the application open on the first device while interacting with the second device, the mobile device instance may be closed, and control of the process may be moved back to or continued at the first device.

Illustrations in FIGS. 3A-C illustrate moving from a desktop to a mobile device to manage portions of the process. However, the initial actions of an application process could begin at a mobile device as the first device, and can move to a desktop device (or other device) as the second device, in other instances, such as where the user began the application process on the go, but has reached their home or work at some point before the end of the process. In these instances, location-based solutions may determine the user is near to a registered computing system location, and may offer without user input to move the application process to the desktop system at the determined location. This may be helpful when application process operations require significant data input, or the process is visually complex and may need a larger screen to easier view terms, conditions, and other process step-related information. However, the present solution envisions transferring the process for any reason, and enabling easy movement between any capable devices.

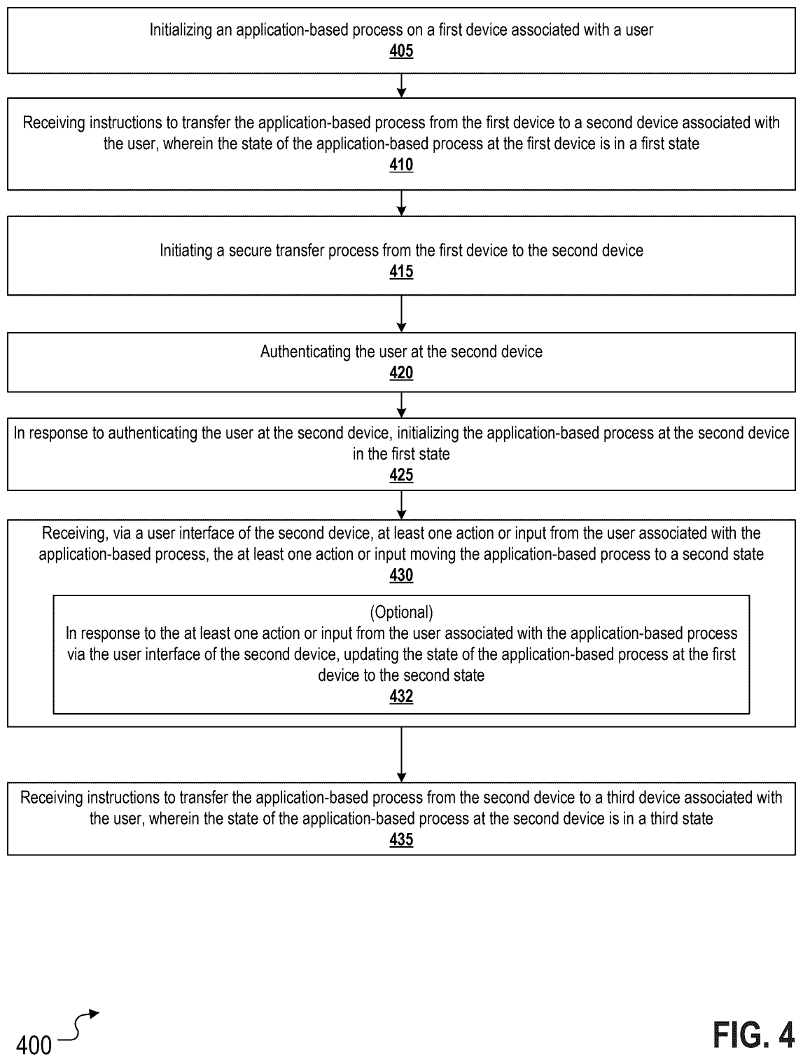

FIG. 4 is a flow diagram of an example method 400 for transferring contexts in an application-based process from a first device associated with a user to a second device associated with the user. It will be understood that process 400 and related methods may be performed, for example, by any suitable system, environment, software, and hardware, or a combination of systems, environments, software, and hardware, as appropriate. For example, a system comprising a communications module, at least one memory storing instructions and other required data, and at least one hardware processor interoperably coupled to the at least one memory and the communications module can be used to execute process 400. In some implementations, the process 400 and related methods are executed by one or more components of the environment 100 described above with respect to FIG. 1, such as the application system 150.

At 405, an application-based process is initialized on a first device associated with a user. As described herein, the application-based process can be associated with any suitable process that requires multiple steps or interactions, such as those associated with interactions associated with financial accounts, IT support, form completion, educational submissions, and others.

At 410, instructions are received or provided to transfer the application-based process from the first device to a second device associated with the user when the application-based process is at a first state at the first device. In some instances, the transfer may occur after the user reaches a step of the application-based process where additional or alternative functionality not available on the first device may be needed to complete the step, or where the user is going from a first fixed location to mobile ongoing location. In some instances, the instruction or indication to transfer may be initiated by the user via a UI at the first device. In other instances, the instruction or indication to transfer may be suggested or provided by the application itself, such as where the application-based process determines that the first device is a first type of device, where the first type of device does not have functionality normally associated with a particular step. For instance, if an image or photo is to be submitted, and a desktop computer as a first device does not have a camera, then the application may automatically suggest and initiate a transfer process. The user may elect to stay on the first device, in some instances, but may have a more convenient second device, such as a mobile phone, that provides the camera functionality to make the image submission simple, and can move forward with the transfer.

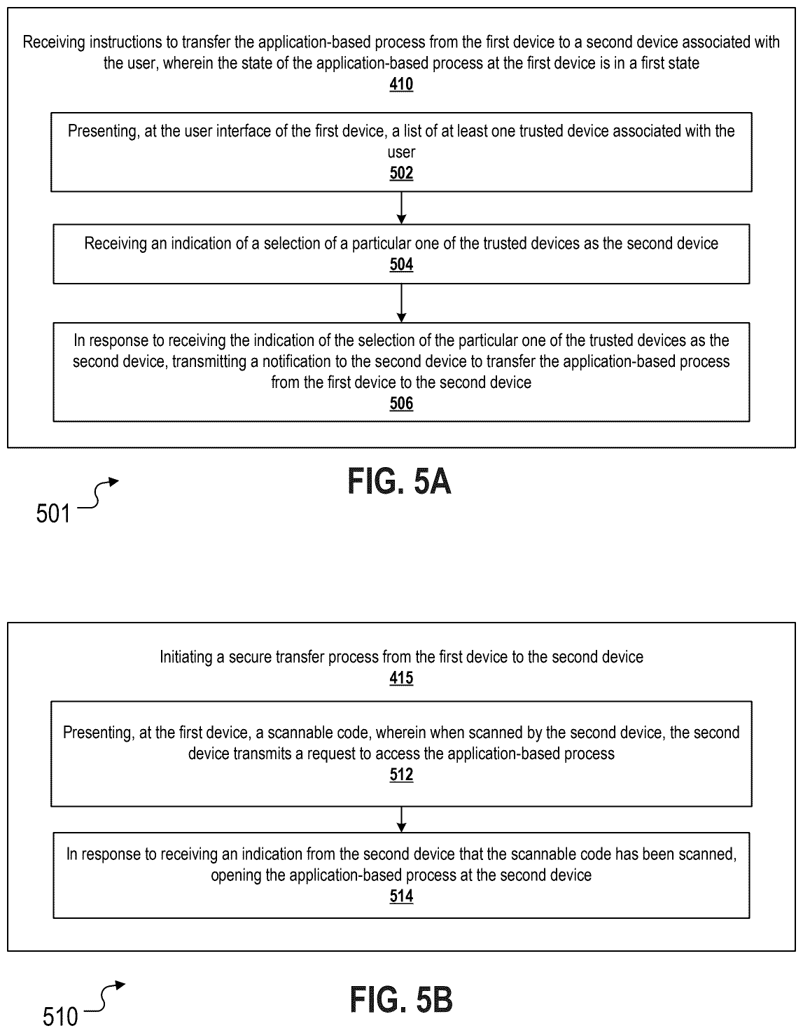

In some instances, such as illustrated in FIG. 5A, in response to receiving the instructions to transfer the process from the first device to a different second device associated with the user, different methods of identifying or specifying the particular second device may be used. In the example method 501 of FIG. 5B, at 502, in response to the instructions, a list of at least one trusted device associated with the user can be presented at the user interface of the first device. In some instance, this can include devices known to be associated with the user, such as those where an application has been installed associated with the entity or business providing the application-based process. Based on the existing connection and prior logins at those other devices, such devices may be known and associated with the user. At 504, an indication of a selection of a particular one of the trusted devices as the second device for the transfer can be received. In response to receiving the selection, a notification is transmitted to the second device to assist in the transfer of the application-based process from the first device to the second device. The notification may be a push notification via an application installed at the second device, or may be a message provided via an SMS-, text-, or email-based communication.

Returning to method 400, at 415, a secure transfer process can be initiated from the first device to the second device. The secure transfer process can be performed as described above. In some instances, such as illustrated in FIG. 5B, initiating the secure transfer process can include the operations of method 510. At 512, for example, the first device can present a scannable code generated by the application system that provides a link or other connection to the application-based process. The scannable code can be scanned or otherwise consumed by the second device, such that the second device can then transmit a request to access the application-based process. The code or link can be unique to the user, and can be used to access the specific state of the process at which the first device was currently at. At 514, in response to receiving an indication from the second device of the scanned code and its associated action or interaction, the application-based process can be opened at the second device.

In some instances, instead of scanning a code, the first device can communicate wirelessly with the second device to provide the information to initiate the secure transfer. The communication can be performed using NFC, Bluetooth, or any other suitable wireless protocol or technique.

Returning to FIG. 4, at 420, the user at the second device is authenticated. In some instances, an IDP system can be used to perform the authentication, and may require the user to enter credentials or other identifying information to confirm that the second device is being used by and is associated with the user. In some instances, the second device (and the first device) may be public or shared devices. To ensure security, each transfer may need to authenticate the users, particularly in such situations.

At 425, in response to authenticating the user at the second device, the application-based process can be initialized at the second device to the first state where the process was at the time of the transfer. The state can be maintained at a backend or centralized application system, and, upon authentication, information associated with that state (i.e., the first state of 410) can be provided to the second device to ensure seamless transition of the application-based process.

At 430, at least one action or input from the user associated with the application-based process is performed at the second device, such as through the user interface of the second device. The at least one action or input can cause the application-based process to move to a second state, different than the prior first state.

In some instances, in response to the at least one action or input that is performed on the second device and that causes the process to move to the second state, the state of the application-based process is updated. In situations where the user has not ended its session on the first device, the movement to the second state on the second device can correspondingly cause the state on the first device to be updated to the second state as well, based on actions at the second device. In doing so, the solution can allow concurrent sessions at the first and second device, and can allow a user to move to the second device for a short period before returning to the first device.

At 435, instructions or another indication to transfer the application-based process from the second device to a third device associated with the user can be received. The state of the application-based process at the second device can be a third state. The third state may be the same as the second state (i.e., directly after the action/input of 430). In other instances, one or more additional inputs, actions, or further activity may have moved the state from the second state to some later third state. The present solution is not limited to a single move from a first device to a second device, but fully allows multiple moves across a plurality of devices. Here, the third device may be a different device than the first device. In those instances, the first device may be a work desktop computer, the second device may be a mobile device, and the third device may be a home desktop or laptop computer.

As described herein, one of the primary use cases are situations where a user cannot complete an application in one sitting at a stationary device, or where the user would need additional functionality (e.g., a camera) to complete an application. However, the techniques described herein could be used in any suitable scenario, including a desktop-to-desktop scenario, among others, or simply for relative convenience. In other instances, the user may need to be mobile while completing an application or process (e.g., due to a meeting, school pick-up, etc.), so may want to take the application with them and their mobile device. The present solution provides significant flexibility in moving from a first, to a second, and, alternatively, to a third, fourth, or more different computing systems in completing the application-based process.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage media (or medium) for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program can, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A system comprising:
at least one memory storing instructions;
a network interface; and
at least one hardware processor interoperably coupled with the network interface and the at least one memory, wherein execution of the instructions by the at least one hardware processor causes performance of operations comprising:
initializing an application-based process on a first device associated with a user;
receiving instructions to transfer the application-based process from the first device to a second device associated with the user, wherein the application-based process at the first device is in a first state;
initiating a secure transfer process from the first device to the second device;
authenticating the user at the second device;
in response to authenticating the user at the second device, initializing the application-based process at the second device in the first state; and
receiving at least one action or input associated with the application-based process from the user at the second device, the at least one action or input moving the application-based process to a second state.

2. The system of claim 1, wherein execution of the instructions by the at least one hardware processor causes performance of operations comprising:
receiving instructions to transfer the application-based process from the second device to a third device associated with the user, wherein the application-based process at the second device is in a third state;
initiating a secure transfer process from the second device to the third device;
authenticating the user at the third device;
in response to authenticating the user at the third device, initializing the application-based process at the third device in the third state.

3. The system of claim 2, wherein the third device is different than the first device.

4. The system of claim 1, wherein the first device is a desktop computer and the second device is a smartphone.

5. The system of claim 1, wherein the first device is a smartphone and the second device is a desktop computer.

6. The system of claim 1, wherein the instructions to transfer the application-based process from the first device to a second device associated with the user are received from a user interface interaction of the user at the first device.

7. The system of claim 1, wherein the instructions to transfer the application-based process from the first device to a second device associated with the user are automatically generated by the application-based process based on a determination that the first device is without a set of functionality associated with a particular operation in the application-based process.

8. The system of claim 7, wherein the particular operation requires camera functionality, wherein the first device does not include camera functionality, and wherein the second device does include camera functionality.

9. The system of claim 1, wherein, after the secure transfer from the first device to the second device and the initialization of the application-based process at the second state, the application-based process remains active at the first device.

10. The system of claim 9, wherein execution of the instructions by the at least one hardware processor causes performance of operations comprising:
in response to receiving the at least one action or input associated with the application-based process from the user at the second device moving the application-based process to the second state, updating the state of the application-based process at the first device to the same second state as the state of the application-based process at the second device.

11. The system of claim 1, wherein initiating the secure transfer process from the first device to the second device comprises:
presenting, at the first device, a scannable code, wherein when the scannable code is scanned by the second device, the second device transmits a request to access the application-based process; and
in response to receiving an indication from that the scannable code has been scanned by the second device, initializing the application-based process at the second device.

12. The system of claim 1, wherein receiving instructions to transfer the application-based process from the first device to a second device associated with the user comprises:
presenting, at a user interface of the first device, a list of at least one trusted device associated with the user other than the first device;
receiving an indication of a selection of a particular one of the at least one trusted devices as the second device; and
in response to receiving the indication of the selection of the particular one of the at least one trusted devices as the second device, transmitting a notification to the second device to transfer the application-based process from the first device to the second device.

13. A non-transitory, computer-readable medium storing computer-readable instructions, that upon execution by at least one hardware processor, cause performance of operations, comprising:
initializing an application-based process on a first device associated with a user;
receiving instructions to transfer the application-based process from the first device to a second device associated with the user, wherein the application-based process at the first device is in a first state;
initiating a secure transfer process from the first device to the second device;
authenticating the user at the second device;
in response to authenticating the user at the second device, initializing the application-based process at the second device in the first state; and
receiving at least one action or input associated with the application-based process from the user at the second device, the at least one action or input moving the application-based process to a second state.

14. The computer-readable medium of claim 13, the operations further comprising:
receiving instructions to transfer the application-based process from the second device to a third device associated with the user, wherein the application-based process at the second device is in a third state;
initiating a secure transfer process from the second device to the third device;
authenticating the user at the third device;
in response to authenticating the user at the third device, initializing the application-based process at the third device in the third state.

15. The computer-readable medium of claim 14, wherein the third device is different than the first device.

16. The computer-readable medium of claim 13, wherein the instructions to transfer the application-based process from the first device to a second device associated with the user are automatically generated by the application-based process based on a determination that the first device is without a set of functionality associated with a particular operation in the application-based process, wherein the particular operation requires camera functionality, wherein the first device does not include camera functionality, and wherein the second device does include camera functionality.

17. The computer-readable medium of claim 13, wherein, after the secure transfer from the first device to the second device and the initialization of the application-based process at the second state, the application-based process remains active at the first device, and the operations further comprising:
in response to receiving the at least one action or input associated with the application-based process from the user at the second device moving the application-based process to the second state, updating the state of the application-based process at the first device to the same second state as the state of the application-based process at the second device.

18. A computer-implemented method, comprising:
initializing an application-based process on a first device associated with a user;
receiving instructions to transfer the application-based process from the first device to a second device associated with the user, wherein the application-based process at the first device is in a first state;
initiating a secure transfer process from the first device to the second device;
authenticating the user at the second device;
in response to authenticating the user at the second device, initializing the application-based process at the second device in the first state; and
receiving at least one action or input associated with the application-based process from the user at the second device, the at least one action or input moving the application-based process to a second state.

19. The method of claim 18, further comprising:
receiving instructions to transfer the application-based process from the second device to a third device associated with the user, wherein the application-based process at the second device is in a third state;
initiating a secure transfer process from the second device to the third device;
authenticating the user at the third device;
in response to authenticating the user at the third device, initializing the application-based process at the third device in the third state.

20. The method of claim 18, wherein, after the secure transfer from the first device to the second device and the initialization of the application-based process at the second state, the application-based process remains active at the first device, and method further comprising:
in response to receiving the at least one action or input associated with the application-based process from the user at the second device moving the application-based process to the second state, updating the state of the application-based process at the first device to the same second state as the state of the application-based process at the second device.
